(19) United States
(12) Patent Application Publication
(10) Pub. No.: US 2003/0021238 A1
(43) Pub. Date: Jan. 30, 2003

(54) Conference as virtual users in multi media network

(76) Inventors: Knut Snorre Bach Corneliussen, Oslo (NO); Espen Skjaeran, Oslo (NO); Espen Iveland, Drammen (NO)

Correspondence Address: NIXON & VANDERHYE P.C., 8th Floor, 1100 North Glebe Road, Arlington, VA, 22201-4714, US

(21) Appl. No.: 10/187,433

(22) Filed: Jul. 2, 2002

(30) Foreign Application Priority Data
Jul. 3, 2001 (NO) 20013304

(51) Int. Cl. H04L 12/16

(52) U.S. Cl. 370/260; 709/204

(57) ABSTRACT

A method of distinguishing one conference from other conferences within a conference unit of a packet switched network is disclosed. This is carried out by allocating a conference identification for the conference, and registering the allocated conference identification into a call server (e.g. a Gatekeeper or a CSCF) as a user identification. The sessions transmitted from the participants of the conference are addressed using the conference identification, and the call server executes the sessions as any other terminating session for a user, and routes the sessions to the conference unit as if the conference unit was a terminating user entity. The method is particularly suitable for IP network supporting the SIP (Session Initiation Protocol) or the H.323 protocol

### FIELD OF THE INVENTION

The present invention is related to packet switched communication network, in particular conferencing services to end-users in a third generation network.

### BACKGROUND OF THE INVENTION

Conference calls has turned out to be a widely used service, replacing ad hoc meetings between participants separated from each other. Conference calls have been available in circuit switched PSTN networks for a long time, mainly based on speech. However, for a conference call to be a satisfactory substitute replacing a personal meeting, it has to offer additional multimedia services like video and data streaming. PSTN networks were originally constructed to support speech only, and are therefore not well suited for transferring multimedia services. Thus, IP networks will instead mainly be utilized as bearers of multimedia conferencing in the future.

3GPP [2] is a IP based standard specifying a node called the MRF (Media Resource Functions). A similar component is the MCU (Multipoint Control Unit) in the H.323v2 [1] standard. The task of the MRF or MCU is to handle multimedia conferencing between two or more end-points in a packet switched network and i.a. to mix the data streams which belongs to the same conference. In the rest of the document these nodes are referred to as conference units. Conferences can either be scheduled or ad-hoc. The logic can either be dial-out (i.e. it is the conference nodes that initiate the session towards the end-points) or it can be dial-in (it is the end-users that dials into the conference unit.)

To identify a conference unit in the network it needs an address that follows the address type in the network. E.g. a H.323ID in an H.323 network or a SIP [1]. URI in a SIP network.

The conference unit address is used as the b-number for dial-in conferences and as the a-number for dial-out conferences.

A problem occurs when one conference unit is handling more than one conference session at the same time. The question is how can the conference unit separate between the different conferences, in respect to which end-user should be added to which conference, and who is allowed to join the different conferences.

One solution for handling the problem described above is to add an extra control or authentication channel. This will work in the way that end-users are asked for a pin code or something similar to authenticate them for the conference. By getting the password the conference unit can check if this user is allowed to join and to which conference the user should be joined. This is described in [4].

However, there are some problems connected with this solution. First of all, one needs to add an extra control channel. Second, the conference unit itself has to check if the user is allowed to join the conference or not. It may be difficult for the conference unit to handle authentication because this functionality is quite different from the conferencing functionality required by the conference unit. A problem also concerns dataflow and traffic handling. Authentication, authorisation and traffic handling are normally taken care of by other nodes in the network, e.g. the gatekeeper in the H.323 network or the SIP server/CSCF in the 3GPP network.

### SUMMARY OF THE INVENTION

It is an object of the present invention to provide a method that eliminates the drawbacks described above. The features defined in the independent claim enclosed characterize this method.

More specifically, the method of the present invention distinguishes a conference from other conferences, within a conference unit of a packet switched network, by allocating a conference identification for that conference, and registering the allocated conference identification into a call server (e.g. a Gatekeeper or a CSCF) as a user identification. The sessions transmitted from the participants of the conference are addressed using the conference identification, and the call server executes the sessions as any other terminating session for a user, and routes the sessions to the conference unit as if the conference unit was a terminating user entity.

### BRIEF DESCRIPTION OF THE DRAWING

FIG. 1 is an illustration of the dataflow for booking and joining a scheduled conference according to the present invention.

### DETAILED DESCRIPTION OF THE INVENTION

There are two main characteristic of the present invention.

1) Every conference is given a conference identifier formatted according to the addressing scheme of that particular system. For a SIP system this means that the conference identifier is a SIP URI. For a H.323 system, any of the H.323 alias types may be used.

2) Every conference is registered as a user in the network with the conference identifier as the user identifier/address.

The following description of a preferred embodiment will use scheduled conferencing as an example, but ad-hoc conferences may also be solved in the same way. The places were ad-hoc differs from scheduled will be described in the text. In the following description, the Conference Unit is typically a MCU in H.323 networks or a MRF in a 3GPP network. The Registrar/Call Server corresponds to a gatekeeper in H.323 networks and a S-CSCF in 3GPP networks. The solution is also applicable in other networks using the SIP protocol other than 3GPP based networks.

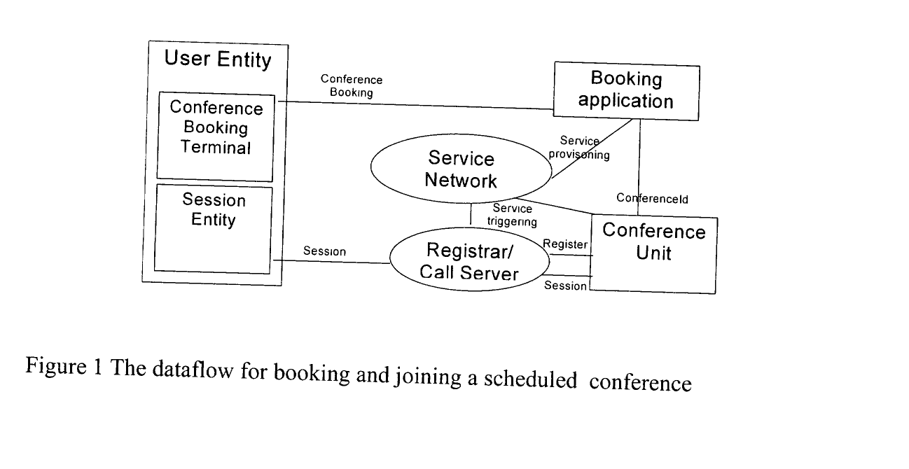

The process of a scheduled conference according to this proposal is shown in FIG. 1.

Booking of a scheduled conference is initiated from the booking application at the user entity. The booking application at the user entity communicates with the booking application in the network. How this is handled is outside the scope of this application. Also, whether the booking application is inside the service network or not, is outside the scope of this application.

The following type of information is typically communicated between the booking application at the user entity and the booking application in the network:

Scheduled time of the conference

The participants of the conference

Preferred conference identifier

Preferred authentication mode (password, certificate, etc.)

The booking application will then, possibly together with the Conference Unit, allocate a conference identifier for the conference. This can be the identifier suggested by the client or an identifier selected by the network. This identifier could be associated with an already existing subscription in the network (a conference subscription), otherwise a subscription for this conference ID must be created and made available to the network in the form of a user and service profile. The identifier is returned to the user entity, and also possibly spread to the other participants using e.g. e-mail.

The Conference Unit will register the conference identifier in the Registrar/Call Server using a normal registration procedure, and the network will know consider the conference as an ordinary user. The Registrar/Call Server may then download the user profile for the conference from a user database and inform the network that sessions for this identifier should be routed through the Registrar/Call Server if needed.

When a user initiates a session towards the conference using the conference identifier, the session will be handled as any other terminating session for a user when reaching the Registrar/Call Server. The service network will be triggered and session related services may be executed before the session is routed to the Conference Unit where the service network may be triggered again for more conference related services. When the conference is finished, the conference identifier is de-registered from the Registrar/Call Server and the identifier is available for re-use.

One advantage of the present invention is that by giving each conference a unique conference identifier, different services may be associated with different conferences. Further, by letting the conference identifier be of the same format as a normal user identifier, routing in the network may follow the same scheme as for any other session.

Still another advantage is that by registering the conference identifier in the call controller (e.g. CSCF), the solution allows for re-use of session oriented services triggered from the call controller. Services that are typically made for end users can therefore be used for conferences as well. One example of such reuse is “Incoming Call Barring (ICB)” that may be used to restrict who is allowed to enter the conference.

Still another advantage is that the Conference Unit while handling more than one conference session at the same time can separate between different conferences in respect to wich end user should be added to wich conference and who is allowed to join the different conferences.

### ABBREVIATIONS

| | |
|---|---|
| SIP | Session Initiation Protocol |
| MRF | Media Resource Function |
| MCU | Multipoint Control Unit |
| URI | Universal Resource Identifier |
| CSCF | Call Session Control Function |
| S-CSCF | Serving-CSCF |
| 3GPP | 3^{rd} Generation Partnership Project |

### REFERENCES

[1] ITU-T Recommendation H.323, 02/98 “Packet-based multimedia communications system.

[2] 3GPP overall architecture. 3GPP TS 23.228 v. 2.0.0

[3] Session Initiation Protocol—SIP IETF RFC 2543, http://www.ietf.org

[4] U.S. Pat. No. 6,138,144 A (DeSimone et al.) Oct. 24, 2000.

1. Method of distinguishing one conference from other conferences within a conference unit of a packet switched network, wherein users are attached to said network by registering associated user identification in a call server within said network,
characterized in
allocating a conference identification for said conference,
registering said conference identification into said call server as a user identification.

2. Method according to claim 1,
characterized in that it further comprises the following step:
in said call server, executing a session addressed to said conference by said conference identification as any other terminating session for a user.
routing said session from the call server to the conference unit as if the conference unit was a terminating user entity.

3. Method according to claim 1 or 2,
characterized in that it further comprises the following step:
spreading the conference identification to all participating users associated thereto.

4. Method according to claim 3,
characterized in that the spreading is carried out by using e-mail.

5. Method according to any of the preceding claims,
characterized in that it further comprises the following step:
creating a conference profile associated to said conference,
storing said conference profile in a subscription database associated with said network,
downloading said conference profile to the call server when registering said conference identification into said call server.

6. Method according to claim 3-5,
characterized in that the participating users of the conference address a session towards the conference by the conference identification.

7. Method according to any of the preceding claims,
characterized in that the packet switched network supports the H.323 protocol, the call server is a Gatekeeper, and the conference unit is a MCU (Multipoint Control Unit).

8. Method according to any of the claims 1-6,
characterized in that the packet switched network supports the SIP protocol, the call server is a CSCF (Call Session Control Function) server, and the conference unit is a MRF (Media Resource Function) unit.

9. Method according to any of the preceding claims, characterized in that the packet switched network is a 3GPP network.
